(19) United States
(12) Patent Application Publication
(10) Pub. No.: US 2012/0239418 A1
(43) Pub. Date: Sep. 20, 2012

(54) Home-Based Post-Operative Care Systems and Methods

(76) Inventor: Neville Brian Flowers, Jamaica, NY (US)

(21) Appl. No.: 13/419,144

(22) Filed: Mar. 13, 2012

Related U.S. Application Data
(60) Provisional application No. 61/452,471, filed on Mar. 14, 2011.

(51) Int. Cl. G06Q 50/22

(52) U.S. Cl. 705/2

(57) ABSTRACT

A method for providing home-based post-operative care of a patient. The method including receiving patient information indicative of results of a pre-operative evaluation of whether a patient is qualified for home-based post-operative care, determining that the patient is qualified for home-based post-operative care based at least in part on the patient information received, identifying one or more post-operative requirements, generating a home-based post-operative care plan based at least in part on the one or more post-operative requirements, receiving updated patient information indicative of results of a post-operative evaluation of whether the patient remains qualified for home-based post-operative care, the updated patient information indicative of a result of the surgical procedure, determining that the patient remains qualified for home-based post-operative care based at least in part on the updated patient information received, and implementing the home-based post-operative care plan.

### PRIORITY CLAIM

This application claims priority to U.S. Provisional Patent Application No. 61/452,471 filed on Mar. 14, 2011, entitled “HOME BASED POSTOPERATIVE CARE METHOD AND SYSTEM”, the disclosure of which is hereby incorporated by reference in its entirety.

### BACKGROUND OF THE INVENTION

1. Field of the Invention

This invention relates generally to providing home-based care to a patient and more particularly to systems and methods for providing home-based care to patients following surgery.

2. Description of the Related Art

After having surgery or similar procedure, a patient typically receives some form of post-operative care. This may include care that is given immediately following a surgery, in the operating room, in the post anesthesia care unit (PACU), and the days following the surgery. Post-operative care often includes monitoring the patient's condition as well as providing necessary treatments to prevent complications and to promote the patient's recovery. The extent of post-operative care may depend on the type of surgery, the patient's health, complications that may arise during surgery and so forth. For example, under normal circumstances, a joint-replacement surgery patient typically requires three to five days of intensive post-operative care before transitioning into other types of care, such as out-patient physical therapy.

Post-operative care is typically conducted at a healthcare facility, such as the hospital where the surgery was conducted. For example, following a joint replacement surgery, the patient may remain in the hospital for three to five days of post-operative care. The patient is normally discharged to return to their home upon completion of post-operative care at the healthcare facility. Unfortunately, post-operative care within a healthcare facility can add to cost (e.g., additional cost associated with a hospital stay), may increase a patient's anxiety, and may require health care facility resources (e.g., bed space, medical practitioner oversight, and so forth). Moreover, a patient's home may not be well suited for the type of care that is required upon the patient's return home, which can lead to further complications in the recovery process. Accordingly, it may be desirable to provide home-based post-operative care that is beneficial to both patients and healthcare providers.

### SUMMARY OF THE INVENTION

Various embodiments of methods and apparatus for providing home-based post-operative care are provided herein. In some embodiments, provided is a computer-implemented method for providing home-based post-operative care of a patient following a surgical procedure. The method including receiving patient information indicative of results of a pre-operative evaluation of whether a patient is qualified for home-based post-operative care, determining that the patient is qualified for home-based post-operative care based at least in part on the patient information received, identifying one or more post-operative requirements, in response to determining that the patient is qualified for home-based post-operative care, generating a home-based post-operative care plan based at least in part on the one or more post-operative requirements, receiving updated patient information indicative of results of a post-operative evaluation of whether the patient remains qualified for home-based post-operative care, the updated patient information indicative of a result of the surgical procedure, determining that the patient remains qualified for home-based post-operative care based at least in part on the updated patient information received, and implementing the home-based post-operative care plan, including: discharging the patient from a medical facility such that the patient may be transported to a home-environment for post-operative care, coordinating visits of one or more care providers to the home environment, receiving visit information indicative of interactions of one or more care providers with the patient in the home environment, logging, with a processor, the visit information, and providing for display of the visit information for review by a medical practitioner, the visit information for use in evaluating the patient being cared for under the home-based post-operative care plan.

In some embodiments, provided is a computer-implemented method that includes serving, to a first client device, a content page having a data input field for the entry of home-evaluation information, receiving, from the first client device prior to the patient being provided home-based post-operative care within a home environment, home-evaluation information indicative of results of an on-site evaluation of the home environment, the home-evaluation information having been provided via the data input field, storing the home-evaluation information, and in response to receiving a request for patient information, serving, to a second client device, patient information comprising at least a portion of the home-evaluation information, the patient information configured to be displayed to a user for use in evaluating whether the patient qualifies for home-based post-operative care within the home environment.

In some embodiments, provided is a computer-implemented method that includes serving, to a first client device, a content page having a data input field for the entry of visit information indicative of home-based post-operative care services provided by a care provider to a patient, receiving, from the client device, visit information indicative of home-based post-operative care services provided by the care provider to the patient, the visit information having been provided via the data input field, storing the visit information, and in response to receiving a request for patient information, serving, to a second client device, patient information comprising at least a portion of the visit information, the patient information configured to be displayed to a user for use in evaluating post-operative care services provided to the patient.

### BRIEF DESCRIPTION OF THE DRAWINGS

FIG. 1 is a diagram that illustrates a patient care coordination system in accordance with one or more embodiments of the present technique.

FIGS. 2A and 2B depict a flowchart that illustrates a method for providing home-based post-operative care in accordance with one more embodiments of the present technique.

FIGS. 3A-3E depict exemplary patient care webpages in accordance with one or more embodiments of the present technique.

FIG. 4 is a flowchart that illustrates a method of generating a HBPOC plan in accordance with one or more embodiments of the present technique.

FIG. 5 is a flowchart that illustrates a method of implementing home-based post-operative care in accordance with one or more embodiments of the present technique.

FIG. 6 depicts an exemplary patient care log in accordance with one or more embodiments of the present technique.

FIG. 7 illustrates an exemplary computer system in accordance with one or more embodiments of the present technique.

### DETAILED DESCRIPTION OF THE PREFERRED EMBODIMENTS

As discussed in more detail below, provided in some embodiments are systems and methods for providing home-based patient care following surgery, referred to herein as “home-based post-operative care”. In some embodiments, prior to conducting a surgery, a pre-operative evaluation is conducted to assess a patient's eligibility for home-based post-operative care, post-operative care requirements are identified and a post-operative care plan is generated. In some embodiments, following the surgery, a post-operative evaluation of the patient is conducted to assess whether the patient remains eligible for home-based post-operative care, and, where the patient remains eligible for home-based post-operative care, the post-operative care requirements for the patient are re-evaluated and the home-based post-operative care plan is updated accordingly. In some embodiments, after a brief recovery period following surgery (e.g., several hours, one day or the like), the patient is discharged to return to their home or a similar environment.

In some embodiments, post-operative care is provided at the patient's home by one or more post-operative care providers (e.g., a nurse, physician's assistant, a phlebotomist, a physical therapist, an ultrasound specialist, etc.) in accordance with the home-based post-operative care plan. For example, in some embodiments, a nurse may be present at the home upon the patient's arrival, and may stay with the patient for a given period of time. In some embodiments, different care practitioners may visit the patient's home to provide home-based services (e.g., administer pain medication, draw fluids, provide physical therapy, etc.) in accordance with the home-based post-operative care plan. In certain embodiments, the care providers may log information regarding patient status and their interactions with the patient at the home. In some embodiments, the logs may be used to generate updated patient information that is reviewed by a medical practitioner (e.g., the surgeon) on a regular basis to evaluate the patient's recovery and determine whether the patient should remain under home-based post-operative care. In certain embodiments, the review may be conducted from a location that is remote from the home environment. For example, the surgeon may review the updated patient information from a computer terminal at the hospital, a laptop computer, a cell phone, a tablet computer or the like, such that the surgeon does not have to physically visit the patient in the home. In certain embodiments, an evaluation may include oral and/or visual communication with the patient. For example, the surgeon may engage the patient via a phone call or a video conference. In some embodiments, upon successful completion of the home-based post-operative care, the patient may be cleared for other activities and treatments based on the outcome of the post-operative care. For example, where the patient is receiving post-operative care that includes home-based physical therapy, the patient may be cleared for physical therapy at an out-patient facility based on their successful completion of home-based post-operative care.

In some embodiments, the home-based post-operative care plan may be coordinated by a home-based post-operative care coordination system. For example, a home-based post-operative care coordination system may include a centralized web-based system that enables medical practitioners to provide assessments of patients, to generate post-operative care plans, to log/record interactions with patients and/or to review patient information via the Internet or similar network based interface. Such a system may facilitate home-based medical care that may otherwise be hampered by the remote location of the patient's home relative to a medical facility, such as the hospital. For example, a home-based post-operative care coordination system may enable care providers to work remotely while providing feedback to medical staff located at the medical facility. Moreover, such a system may provide for the collection of information that is not typically accessible to a medical practitioner. For example, the system may enable collection and evaluation of data regarding the conditions of the patient's home, such that a medical practitioner can adjust post-operative care to suit the individual conditions of the patient, thereby helping to reduce risk that may be associated with patients returning to homes that are not suitable for recovery.

Although several of the embodiments are described herein with regard to exemplary procedures, treatments and medical practitioners, the technique described herein may be employed for various procedures treatments and medical practitioners. For example, the techniques described herein may be employed for joint replacement surgeries (e.g., knee replacement, hip replacement, etc.) or other procedures that require extensive post-operative care. As a further example, several of the embodiments are described with regard to a particular type of practitioner, although they may be accomplished by the same person and/or different types of practitioners. For example, in some embodiments, the medical assistant and a care coordinator described herein may be the same individual.

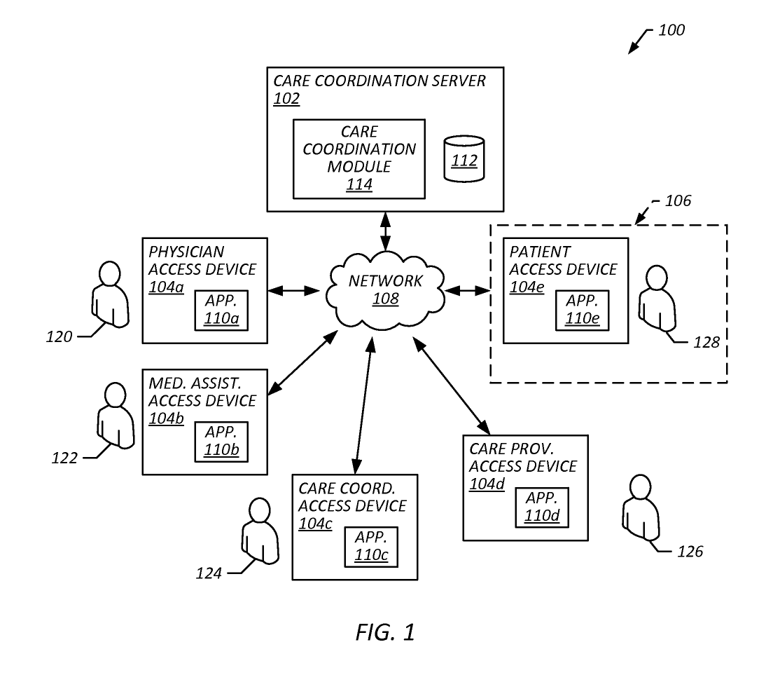

FIG. 1 is a diagram that illustrates a patient care coordination system (“system”) 100 in accordance with one or more embodiments of the present technique. In some embodiments, system 100 includes a care coordination server (“server”) 102, a physician access device 104a, a medical assistant access device 104b, a care coordinator access device 104c, one or more care provider access devices 104d, and a patient (“home”) access device 104e. Home access device 104e may be provided in a home environment 106. In some embodiments, the entities of system 100 may be communicatively coupled via a network 108.

In some embodiments, network 108 may include an element or system that facilitates communications between entities of system 100. For example, network 108 may facilitate communication between server 102 and access devices 104a, 104b, 104c, 104d and 104e (referred to collectively as access devices 104). In some embodiments, network 108 may include an electronic communications network, such as the Internet, a local area network (LAN), a wide area (WAN), a cellular communications network or the like. In some embodiments, network 108 may include a single network or combination of networks.

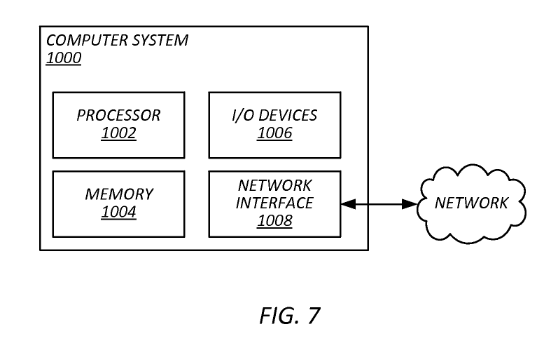

Access devices 104 may include devices capable of communicating information via network 108. For example, access devices 104 may include a personal computer (e.g., a desktop computer), a mobile computing device (e.g., a laptop or tablet computer), a cellular communication device (e.g., a cellular phone), a personal digital assistant (PDA), or the like. In some embodiments, access devices 104 may be client devices of server 102. In some embodiments, access devices 104 may include various input/output (I/O) interfaces. For example access devices 104 may include a graphical user interface (e.g., display screen), an audible output user interface (e.g., speaker), an audible input user interface (e.g., microphone), a keyboard, a pointer/selection device (e.g., mouse, trackball, touchpad, touchscreen, stylus or the like), a printer, or the like. In some embodiments, access devices 104 may include general computing components and/or embedded systems optimized with specific components for performing specific tasks. In some embodiments, access devices 104 may include computer systems similar to that of computer system 1000 described below with regard to at least FIG. 7.

In some embodiments, access devices 104 may include programs/applications that can be used to generate a request for content, to provide content, to render content, and/or to send/receive request to/from other devices via network 108. For example, access devices 104 may employ applications 110a, 110b, 110c, 110d, and 110e, respectively (referred to collectively as applications 110). In some embodiments, applications 110 may include client applications used for communicating with server 102 and/or similar applications of other access devices (e.g., in a peer-to-peer communication). In some embodiments, applications 110 may include a web-based care coordination application. For example, applications 110 may include an Internet browser application and/or a local care coordinator client application that facilitates communication with server 102 and/or other entities of system 100 to facilitate coordination of post-operative patient care. In some embodiments, applications 110 may include modules having program instructions that are executable by a computer system to perform some or all of the functionality described herein with regard to respective access devices 104. In some embodiments, access devices 104a, 104b, 104c, 104d and 104e may be used by a surgeon/physician 120, a medical assistant 122, a care coordinator 124, care provider(s) 126 and a patient 128, respectively.

In some embodiments, server 102 may include an entity that serves client request relating to patient care. For example, server 102 may include a webserver that serves webpages, including patient care information, to access devices 104. In some embodiments, server 102 may provide for receipt and storage of patient information. For example, server 102 may provide a web-based system for receiving patient information via applications 110 of access devices 104 and/or storing the received patient information in a datastore 112. Datastore 112 may include a database or similar repository for storing information. In some embodiments, server 102 may include a care coordination module 114. Care coordination module 114 may include program instructions that are executable by a computer system to perform some or all of the functionality described herein with regard to server 102. In some embodiments, server 102 may include a computer system similar to that of computer system 1000 described below with regard to at least FIG. 7.

Home environment 106 may include a home of a patient (e.g., patient 128) or a similar environment. For example, home environment 106 may include a home of a friend or family member of the patient or other private residence. Home environment may be located remote from a medical facility (e.g., a hospital) where the patient's surgery is conducted and/or would typically receive post-operative care (e.g., on-site post-operative care) during recovery.

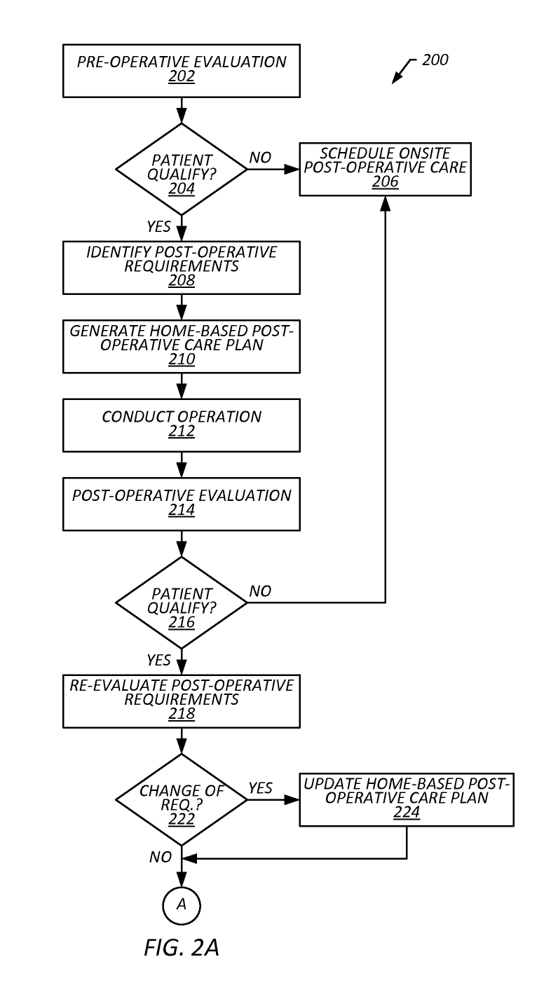

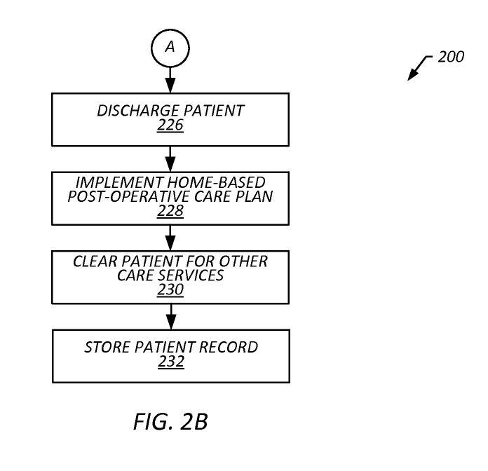

FIGS. 2A and 2B depict a flowchart that illustrates a method 200 for providing home-based post-operative care in accordance with one more embodiments of the present technique. In some embodiments, method 200 may generally include a pre-operative evaluation to determine whether or not a patient is eligible for home-based post-operative care and, where the patient does qualify, identifying post-operative requirements and generating a home-based post-operative care plan. In some embodiments, method 200 may generally include a post-operative evaluation (e.g., after surgery is complete) to determine whether or not the patient remains eligible for home-based post-operative care and, where the patient does remain qualified, determining whether the post-operative requirements have changed and, if so, updating the home-based post-operative care plan. In some embodiments, method 200 may generally include implementing the home-based post-operative care plan and, during implementation of the home-based post-operative care plan, logging/recording patient information (e.g., patient status information and interactions with the patient), review of the patient information by a surgeon/physician and/or updating of the home-based post-operative care plan as needed until the home-based care is complete and/or the patient is cleared for other care services (e.g., out-patient physical therapy).

Method 200 may include a pre-operative evaluation, as depicted at block 202. In some embodiments, a pre-operative evaluation may be conducted by a medical practitioner overseeing a surgery to determine whether or not a patient qualifies for home-based post-operative care. In some embodiments, a medical consultation may be conducted to determine whether the patient's home is suitable for post-operative care. For example, a care coordinator overseeing the procedure may visit the patient's home to assess conditions within a patient's home (e.g., sanitary conditions, physical access, etc.), to interview the patient and/or family members or friends that may be available to care for the patient, and provide an evaluation of whether or not the patient is a suitable candidate for home-based post-operative care based on the consultation. In some embodiments, the care coordinator may provide patient information, including the results of their evaluation, to server 102 for storage in datastore 112.

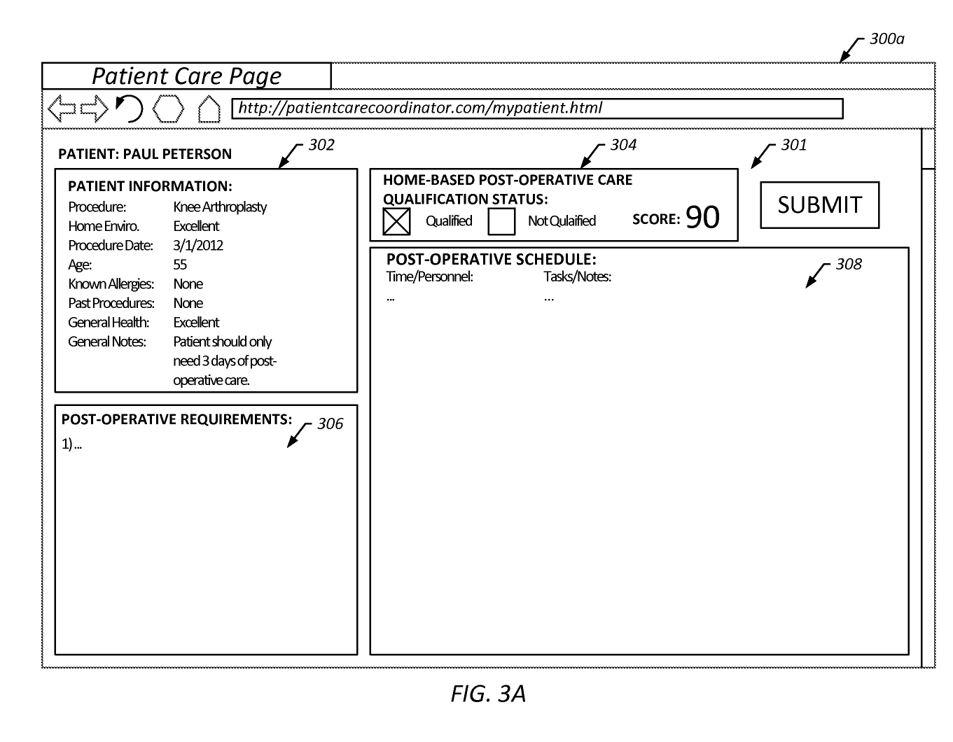

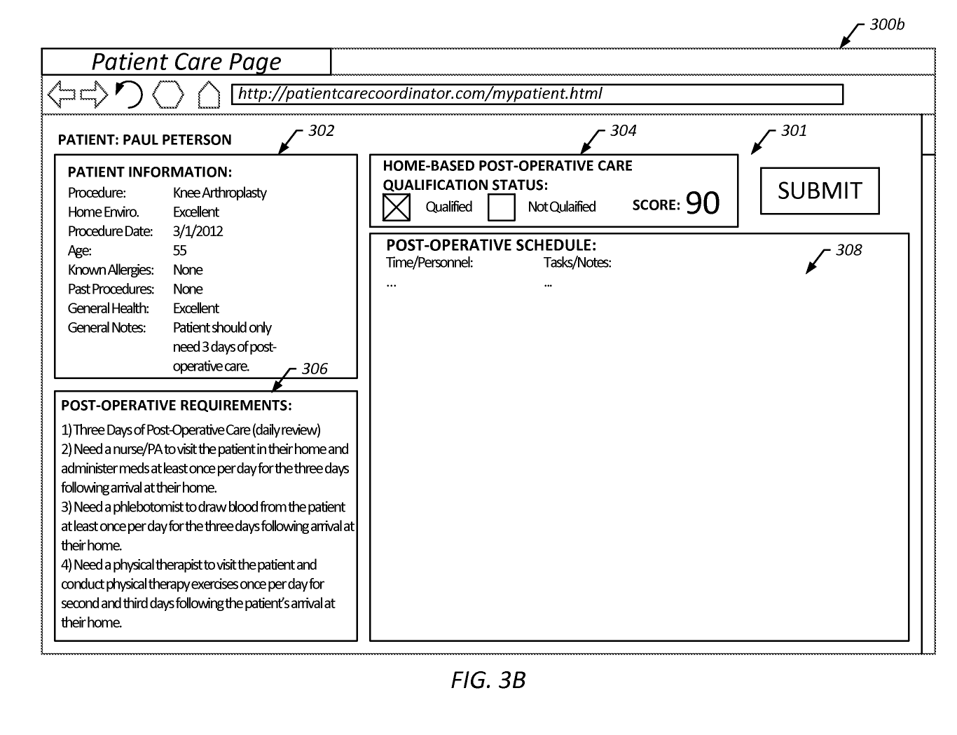

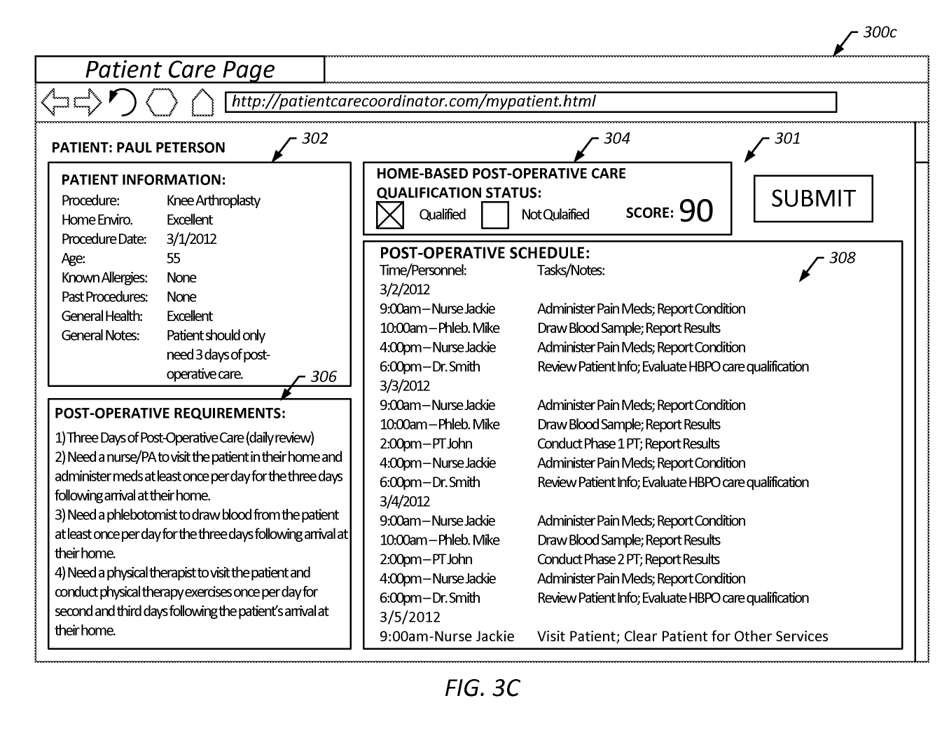

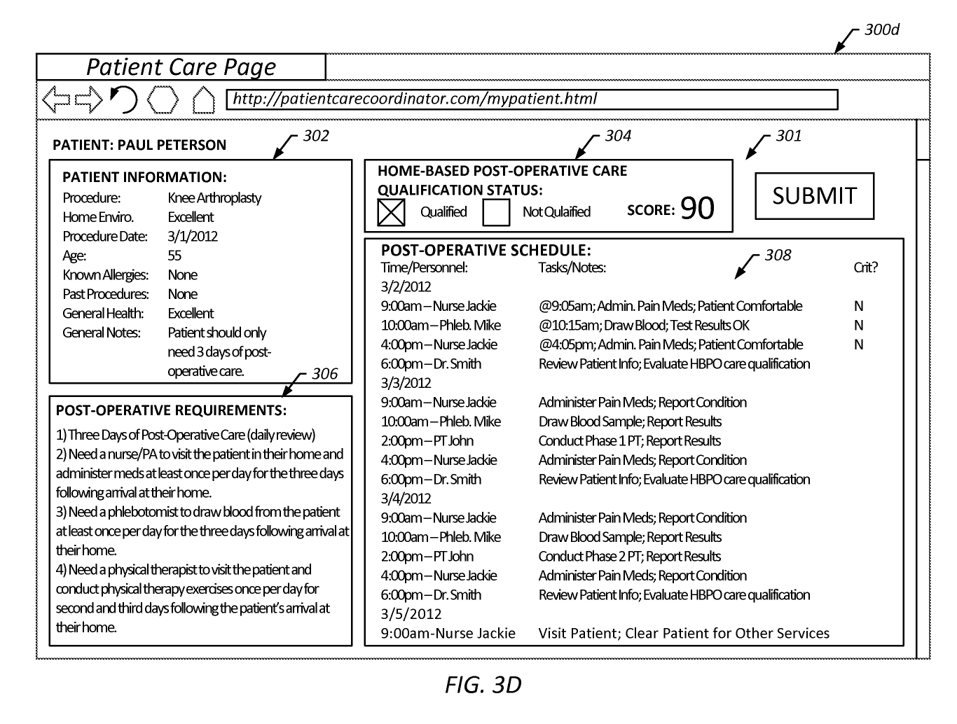

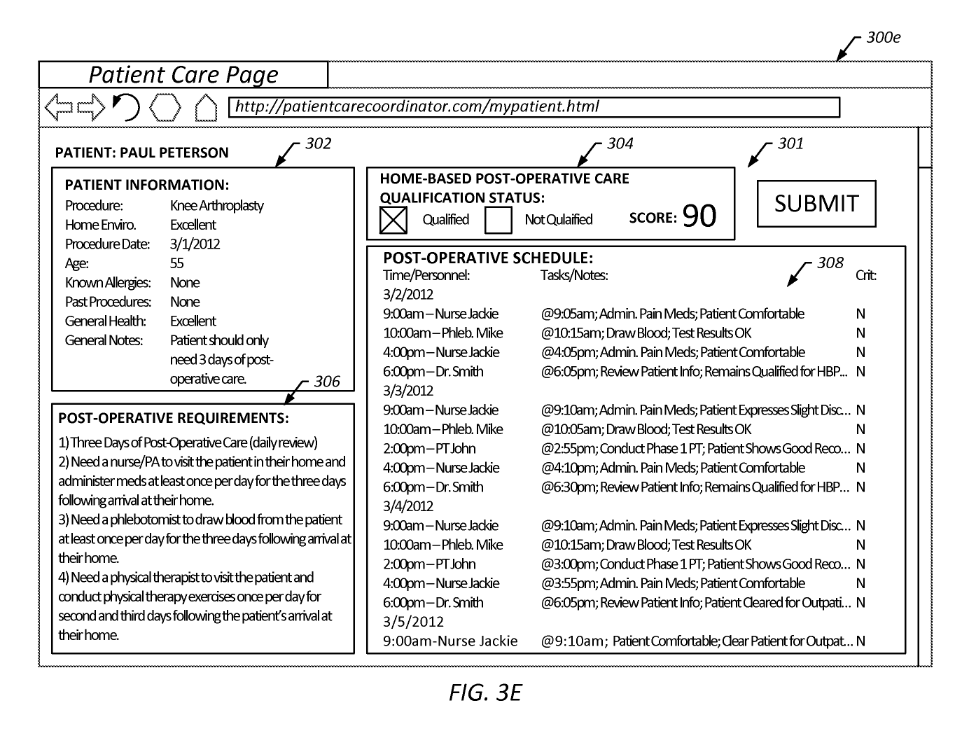

FIG. 3A depicts an exemplary patient care webpage 300a including patient information in accordance with one or more embodiments of the present technique. In some embodiments, webpage 300a may include a patient information section 302, an evaluation section 304, a post-operative requirements section 306 and a post-operative schedule/log 308.

In some embodiments, the medical practitioner may be assisted in their evaluation by system 100. For example, after conducting the evaluation of the patient's home, the care coordinator may log-in (e.g., via application 110c of access device 104c) to a “patient care website” served by care coordinator server 102, and request to access the patient's records (e.g., records for patient “Paul Peterson”). In response to the request, server 102 may serve content, such as a webpage similar to that of FIG. 3A, including the patient's care information, or at least fields for the entry/modification of patient care information. In some embodiments, the care coordinator may enter patient information via the webpage. For example, referring to FIG. 3A, the care coordinator may enter patient information (e.g., the type of procedure, a type of implant used, patient's demographics, the name and age of the patient, the patient's medical history, the location and condition of the patient's home, and so forth) in patient information section 302. In some embodiments, updated information, including the information entered by the care coordinator via the webpage, may be submitted to server 102 upon selection of the “Submit” button. In some embodiments, the patient's information/record stored at datastore 112 may be updated to reflect the coordinator's evaluation and/or other information provided.

In some embodiments, the pre-operative evaluation may be based on various types of information collected about the patient. For example, in the case of a patient that is scheduled to undergo a joint replacement surgery, the surgeon that is scheduled to perform the operation may review the patient's information to determine whether or not the patient qualifies for home-based post-operative care or would be better suited for on-site post-operative care (e.g., at a hospital or similar medical facility). In some embodiments, the medical practitioner may consider numerous factors in making the determinations. For example, the surgeon may base their decision on the type of procedure, the age of the patient, the patient's medical history, the location and condition of the patient's home, and so forth.

In some embodiments, the medical practitioner may be assisted in the pre-operative evaluation by information collected and provided by care coordination system 100. For example, upon initiation of the pre-operative evaluation, the surgeon may log-in (e.g., via application 110a of access device 104a) to a “patient care website” served by care coordinator server 102, and request to access the patient's records. In response to the request, server 102 may serve content, such as a webpage similar to webpage 300a, including the patient's care information 301.

In some embodiments, the medical practitioner may provide an indication of whether or not the patient qualifies for home-based post-operative care. For example, referring to FIG. 3A, upon reviewing patient information 302 including notes or other patient care information previously provided by the care coordinator, the surgeon may select the radio button for “Qualified”, indicating that the patient does qualify for home-based post-operative care, or the surgeon may select the radio button for “Not Qualified”, indicating that the patient does not qualify for home-based post-operative care.

In some embodiments, results of an automated evaluation may be provided to assist the medical practitioner in their evaluation. For example, in some embodiments, server 102 may process the current patient information to generate a score that is indicative of the patient's qualification for home-based post-operative care. A high score (e.g., above a threshold score) may be indicative of the patient being well suited for home-based post-operative care, where as a low score (e.g., below a threshold score) may be indicative of the patient being less suited for home-based post-operative care (e.g., being suited for on-site post-operative care). In some embodiments, the score may be provided to the practitioner to provide guidance in determining whether or not the patient qualifies for home-based post-operative care. For example, the evaluation section 304 includes a score having a value of “90”. Where a threshold score is “70”, the score of “90” may be indicative of the patient being well qualified for home-based post-operative care based at least on the patient information submitted. Other embodiments may include various indicators, such as “Highly Qualified”, “Moderately Qualified”, and “Poorly Qualified”.

In some embodiments, the surgeon may modify the patient information. For example, the surgeon may enter “Patient should only need 3 days of post-operative care” in the “General Notes” of patient information section 302. Notably, in some embodiments, post-operative requirements section 306 and a post-operative schedule/log 308 are blank at this stage as the post-operative requirements and the schedule/log may be provided at a later time.

In some embodiments, updated information, including the information entered by the surgeon via the webpage, may be submitted to server 102 upon selection of the “Submit” button. In some embodiments, the patient's information/record stored at datastore 112 may be updated to reflect the surgeons evaluation that that the patient does or does not qualify for home-based post-operative care and/or the notes entered by the surgeon.

Method 200 may include determining whether a patient qualifies for home-based post-operative care, as depicted at block 204. In some embodiments, determining whether a patient qualifies for home-based post-operative care may be based on the pre-operative evaluation. For example, server 102 may determine that a patient does qualify for home-based post-operative care based on the surgeon's selection and submission of “Qualified”. As a further example, server 102 may determine that a patient does not qualify for home-based post-operative care based on the surgeon's selection and submission of “Not Qualified”.

In some embodiments, where it is determined that a patient does not qualify for home-based post-operative care, method 200 may include proceeding to scheduling on-site post-operative care, as depicted at block 206. For example, where it is determined that a patient scheduled to have surgery at a hospital does not qualify for home-based post-operative care, server 102 may proceed with automatically generating notifications (e.g., e-mails) prompting personnel (e.g., a care coordinator) to coordinate on-site post-operative care at the hospital.

In some embodiments, where it is determined that a patient does qualify for home-based post-operative care, method 200 may include proceeding to identifying post-operative requirements, as depicted at block 208. In some embodiments, identifying post-operative requirements may include identifying the types of services required (e.g., visit, administer medications, draw fluids, physical therapy, etc.), the duration and frequency of services required (e.g., hourly, daily, etc.), the persons responsible for competing those services (e.g., a nurse, a physician's assistant (PA), a phlebotomist, a physical therapist, etc.), changes that may need to be made to the home environment (e.g., addition of medical beds in the bedroom), equipment that may be required (e.g., monitors, medical supplies, etc.) and so forth. For example, identifying post-operative requirements may include identifying, for the patient having a joint replacement, that three days of postoperative care with daily physician review is required, that a nurse/PA needs to visit the patient in their home and administer medications at least once per day for the three days following the patient's arrival at the home, a phlebotomist needs to take a blood sample from the patient for testing at least once per day for the three days following the patient's arrival at the home, and a physical therapist needs to visit the patient and conduct physical therapy exercises once per day for the second and third days following the patient's arrival at their home. In some embodiments, the post-operative requirements may be based on various factors, such as the type of procedure, the patient's medical history, the location and condition of the patient's home, and so forth.

In some embodiments, system 100 may facilitate the identification and entry of post-operative requirements. For example, in response to determining that a patient is qualified for home-based post-operative care based on the surgeon's input via a webpage, server 102 may proceed with automatically generating notifications (e.g., e-mails) prompting personnel (e.g., a medical assistant) to identify post-operative requirements.

In some embodiments, a medical practitioner may identify post-operative requirements based on the current information for the patient. For example, a surgeon's medical assistant may enter post-operative requirements for three days of home-based post-operative care based on the evaluation and general notes previously submitted by the care coordinator and/or the surgeon.

In some embodiments, the medical practitioner may be assisted in the identification and entry of post-operative requirements by information collected and provided by care coordination system 100. For example, in response to receiving a notification that the surgeon has approved the patient for home-based post-operative care, the surgeon's medical assistant may log-in (e.g., via application 110b of access device 104b) to the “patient care website” served by care coordinator server 102, and request to access the patient's records. In response to the request, server 102 may serve content, such as a webpage, including the patient's current care information.

FIG. 3B depicts an exemplary patient care webpage 300b including post-operative requirements in accordance with one or more embodiments of the present technique. In some embodiments, a medical practitioner may update the post-operative requirements to include the identified post-operative requirements. For example, upon reviewing patient information of webpage 300b, the medical assistant may enter, within “Post-Operative Requirements” section 306, the following requirements: “1) Three Days of Post-Operative Care (daily review)”; “2) Need a nurse/PA to visit the patient in their home and administer meds at least once per day for the three days following arrival at their home”; “3) Need a phlebotomist to draw blood from the patient at least once per day for the three days following arrival at their home”; and “4) Need a physical therapist to visit the patient and conduct physical therapy exercises once per day for second and third days following the patient's arrival at their home”. Notably, in some embodiments, post-operative schedule/log 308 is blank at this stage as the content of the schedule/log may be provided at a later time.

In some embodiments, updated information, including the post-operative requirements entered by the medical assistant via webpage 300b, may be submitted to server 102 upon selection of the “Submit” button. In some embodiments, the patient's information stored at datastore 112 may be updated to reflect the post-operative requirements entered by the medical assistant.

Method 200 may include generating a home-based post-operative care (HBPOC) plan, as depicted at block 210. In some embodiments, the HBPOC plan may be based on the patient care information, including the post-operative requirements. For example, a care coordinator may identify the dates and times at which post-operative services are required, identify medial practitioners that are available and qualified to perform the services, and may generate a corresponding HBPOC plan. In some embodiments, an HBPOC plan outlines services to be provided, when they are to be provided, where they are to be provided, and/or which personnel is responsible for providing the service. For example, an HBPOC plan for the patient having a joint replacement, may specify or otherwise indicate the following: (1) Nurse “Jackie Smith”—visit patient in home and administer medications in the mornings and afternoons of March 2^{nd}, 3^{rd} and 4^{th}; (2) Phlebotomist “Mike Green”—draw a blood sample from the patient in home at 10 am of March 2^{nd}, 3^{rd} and 4^{th}; (3) Physical Therapist (PT) “John Lane”—provide physical therapy in the afternoons of March 3^{rd} and 4^{th}; and (4) “Dr. Mike Smith”—review the patient information and evaluate the HBPOC plan qualifications at or around 6 pm of March 2^{nd}, 3^{rd} and 4^{th}.

In some embodiments, the medical practitioner may be assisted in generating the HBPOC plan by information collected and provided by care coordination system 100. For example, in response to receiving a notification that the medical assistant has submitted post-operative care requirements, the care coordinator may log-in (e.g., via application 110c of access device 104c) to the “patient care website” served by care coordinator server 102, and request to access the patient's records. In response to the request, server 102 may serve content, such as a webpage, including the patient's current care information.

FIG. 3C depicts an exemplary patient care webpage 300c including a schedule for a home-based post-operative plan in accordance with one or more embodiments of the present technique. In some embodiments, a medical practitioner may generate/update a post-operative schedule in accordance with the identified post-operative requirements and/or other patient care information. For example, upon reviewing patient information and post-operative requirements of webpage 300c, the care coordinator may enter a post-operative schedule that is indicative of the scheduled times and personnel required for performing services to meet the post-operative requirements identified.

In some embodiments, updated information, including the HBPOC plan, with the post-operative schedule provided by the care coordinator via the webpage, may be submitted to server 102 upon selection of the “Submit” button. In some embodiments, the patient's information stored at datastore 112 may be updated to reflect the HBPOC plan/schedule entered by the care coordinator.

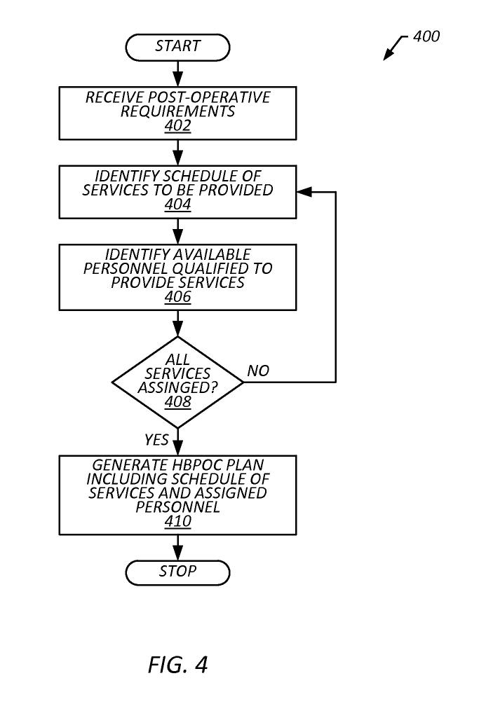

In some embodiments, server 102 may automatically generate some or all of an HBPOC plan based at least in part on identified requirements. For example, the schedule of tasks may be generated automatically and/or individual care providers may be assigned to the tasks automatically. FIG. 4 is a flowchart that illustrates a method 400 of generating a HBPOC plan in accordance with one or more embodiments of the present technique. Method 400 may include receiving post-operative requirements, as depicted at block 402. In some embodiments, the post-operative requirements may include requirements based on the pre-operative evaluation. For example, the requirements specified/identified at block 208 may be received or retrieved from datastore 112. Method 400 may include identifying a schedule of services to be provided, as depicted at block 404. In some embodiments, identifying a schedule of services to be provided may include identifying one or more services that correspond to the post-operative requirements. For example, where a look-up-table is stored that includes a listing of various post-operative requirements and corresponding sets of services for each of the individual requirements, a corresponding set of service (e.g., the two nurse visits each of the three days) may be identified for each of the post-operative requirements (e.g., “need a nurse/PA to visit the patient in their home and administer meds at least once per day for the three days following arrival at their home”) using the look-up-table. In some embodiments, the relationship between services may be pre-determined such that services are scheduled in an appropriate order. For example, services may be scheduled based on a predetermined relationship, such as a relationship specifying that a nurse shall visit the patient less than two hours prior to a phlebotomist arriving to take fluids. Method 400 may include identifying available personnel qualified to provide services, as depicted at block 406. In some embodiments, identifying available personnel qualified to provide services may include assessing a database of care provider information stored at datastore 112 to identify, for each of the scheduled services, personnel that are available (e.g., qualified personnel not scheduled to provide services to another patient at a conflicting time that is the same or similar to the scheduled time of the service) and that have the necessary qualifications (e.g., the personnel is a certified phlebotomist where a phlebotomist is required to perform the service). In some embodiments, method 400 may include determining whether or not all of the services have been assigned personnel that are available and qualified, as depicted at block 408. In some embodiments, where not all services have been assigned personnel that are available and qualified (e.g., because no qualified personnel were available at the time of the schedule service), the schedule or services may be regenerated or otherwise modified (e.g., reworked) and/or a personnel may be assigned to the modified schedule of services in an attempt to ensure that qualified personnel is assigned to each task of the schedule of services, as illustrated by the arrow returning to block 404 in FIG. 4. Such iterations may continue until a schedule is provided that includes qualified personnel assigned to each task of the schedule of services. In some embodiments, method 400 may include generating an HBPOC plan including the schedule of services and assigned personnel, as depicted at block 410. For example, an HBPOC plan having a schedule similar to that provided in schedule 308 of webpage 300c of FIG. 3C may be generated and stored in datastore 112. In some embodiments, such an automatically generated HBPOC plan may be used to populate the displayed schedule (e.g., schedule 308 of webpage 300c of FIG. 3C may be based on the automatically created schedule).

Method 200 may include conducting the operation, as depicted at block 212. In some embodiments, conducting the operation may include physically performing the procedure on the patient. For example, where the patient is schedule to undergo a knee arthroplasty (i.e., a knee replacement), conducting the operation may include the surgeon performing the knee arthroplasty. In some embodiments, the operation may take place in a surgery room of a hospital or similar medical facility.

Method 200 may include a post-operative evaluation, as depicted at block 214. In some embodiments, a post-operative evaluation may include a medical practitioner re-evaluating the patient post-surgery to determine whether or not the patient is still qualified for home-based post-operative care. For example, the surgeon that performed the operation may review the patient's information and the results of surgery to determine whether the patient remains qualifies for home-based post-operative care or would be better suited for on-site post-operative care (e.g., at a hospital or similar medical facility). Such a re-evaluation may enable the medical practitioner to re-assess the patient's qualification for home-based post-operative care, taking into account any changes that may have occurred as a result of the operation. For example, where the patient incurred complications during surgery, the surgeon may have the opportunity to identify the patient as being unqualified for home-based post-operative care. In some embodiments, the post-operative evaluation may include a pre-discharge visit to the patient's home to ensure that the home environment is still suitable for home-based post-operative care. Information regarding the surgery and/or the home evaluation may be submitted to server 102 via a webpage in a manner that is similar to that described above.

In some embodiments, the medical practitioner may be assisted in the pre-operative evaluation by information collected and provided by care coordination system 100. For example, upon initiation of the post-operative evaluation, the surgeon may log-in (e.g., via application 110a of access device 104a) to the “care website” and request to access the patient's records. In response to the request, server 102 may serve content, such as a webpage similar that of webpage 300c of FIG. 3C, including the patient's current care information through surgery. Upon reviewing the patient's information, the surgeon may select (or leave selected) the radio button for “Qualified” to indicate that the patient is still qualified for home-based post-operative care, or the surgeon may select the radio button for “Not Qualified” to indicate that the patient no longer qualifies for home-based post-operative care. The medical practitioner may make modifications to other portions of the patient information. For example, the surgeon may enter additional notes regarding the surgery and the patient's condition in the “General Notes” of patient information 306. In some embodiments, updated information, including the information entered by the surgeon for the post-operative evaluation, may be submitted to server 102 upon selection of the “Submit” button. In some embodiments, the patient's information stored at datastore 112 may be updated to reflect the surgeons evaluation that that the patient does or does not qualify for home-based post-operative care and/or the notes entered by the surgeon.

Method 200 may include determining whether a patient qualifies for home-based post-operative care, as depicted at block 216. In some embodiments, determining whether a patient qualifies for home-based post-operative care may be based on the post-operative evaluation. For example, server 102 may determine that a patient does qualify for home-based post-operative care based on the surgeon's selection and submission of “Qualified”. As a further example, server 102 may determine that a patient does not qualify for home-based post-operative care based on the surgeon's selection and submission of “Not Qualified”.

In some embodiments, where it is determined that a patient does not qualify for home-based post-operative care, method 200 may include proceeding to scheduling on-site post-operative care, as depicted at block 206. For example, where it is determined that the patient having had knee arthroplasty surgery at the hospital no longer qualifies for home-based post-operative care based on the surgeon's selection and submission of “Not Qualified”, server 102 may proceed with automatically generating notifications (e.g., e-mails) prompting personnel (e.g., a care coordinator) to coordinate on-site post-operative care at the hospital.

In some embodiment, where it is determined that a patient remains qualified for home-based post-operative care, method 200 may include proceeding to re-evaluating post-operative requirements, as depicted at block 218. For example, in response to determining that a patient remains qualified for home-based post-operative care, server 102 may proceed with automatically generating notifications (e.g., e-mails) prompting personnel (e.g., a medical assistant) to re-evaluate post-operative requirements. In some embodiments, re-evaluating post-operative requirements may include assessing the patient's current care information to determine whether any changes in the post-operative requirements are needed. For example, the medical assistant may review a webpage similar to that of webpage 300c of FIG. 3C, including any post-operative information (e.g., comments) provided by the surgeon, to determine whether or not the patient requirements need to be adjusted. For example, if the surgeon were to add notes that the patient needs five days of home-based post-operative care, the medical assistant may modify the post-operative requirements to reflect the additional two days of care required. In some embodiments, updated information, including the information entered by the medical assistant for the re-evaluation of post-operative requirements, may be submitted to server 102 upon selection of the “Submit” button. In some embodiments, the patient's care information stored at datastore 112 may be updated to reflect any changes resulting from the medical assistant's re-evaluation of the post-operative requirements.

Method 200 may include determining whether the post-operative requirements have changed, as depicted at block 222. In some embodiments, determining whether the post-operative requirements have changed may be based on whether or not changes have been made to the post-operative requirements. For example, server 102 may determine that the post-operative requirements have changed where the medical assistant has changed the information listed in the post-operative requirements section 306 of the patient care page (e.g., added requirements for days four and five of the home-based post-operative care). As a further example, server 102 may determine that the post-operative requirements have not changed where the medical assistant has not changed the information listed in the post-operative requirements section 306 of the patient care page.

In some embodiments, where it is determined that the post-operative requirements have changed, method 200 may include proceeding to updating home-based post-operative care plan, as depicted at block 224. For example, where it is determined that the post-operative requirements have been changed, server 102 may proceed with automatically generating notifications (e.g., e-mails) prompting personnel (e.g., a care coordinator) to update the home-based post-operative plan in view of the changes. In some embodiments, updating the home-based post-operative care plan may include modifying the plan to ensure that it meets the current post-operative requirements. For example, where the requirements have been changed to reflect an additional services required for days four and five, pursuant to the surgeon's request, the care coordinator may access a webpage similar to that of webpage 300c of FIG. 3C, and enter changes to the schedule/log of the HBPOC plan. In some embodiments, updated information, including the updated HBPOC plan, may be submitted to server 102 upon selection of the “Submit” button. In some embodiments, the patient's information stored at datastore 112 may be updated to reflect any changes resulting from the care coordinator's changes to the HBPOC plan.

In some embodiments, where it is determined that the post-operative requirements have not changed and/or the HBPOC plan has been updated in accordance with changes to the post-operative requirements, method 200 may include proceeding to discharging the patient, as depicted at block 226. In some embodiments, discharging the patient may include discharging the patient from the medical facility at which the operation was performed and/or care following the operation was provided, to their home or a similar home environment. For example, where the patient has undergone a knee arthroplasty at the hospital received basic post-operative care immediately following the surgery and is good condition, the patient may be discharged such that they can return to their home (e.g., home environment 106) for the remainder of the post-operative care.

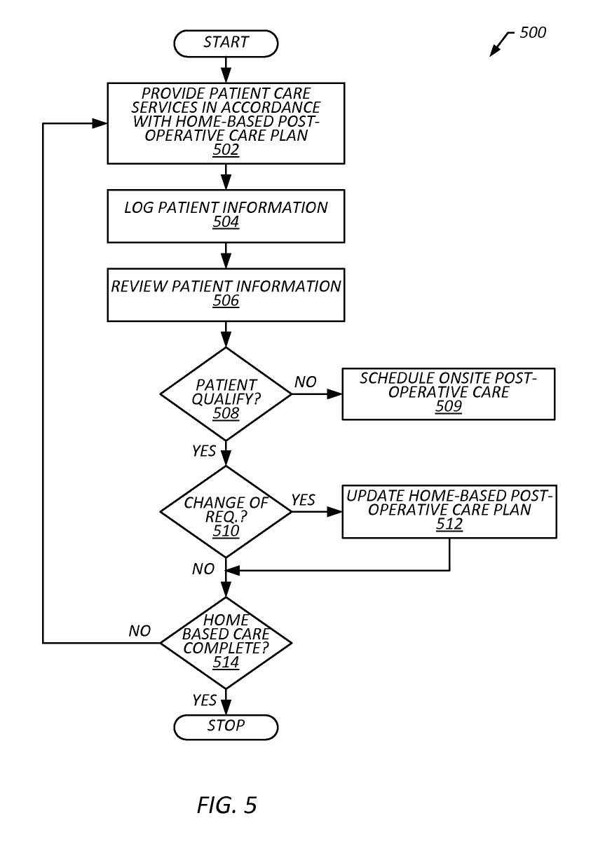

Method 200 may include implementing the HBPOC plan, as depicted at block 228. FIG. 5 is a flowchart that illustrates a method 500 of implementing home-based post-operative care in accordance with one or more embodiments of the present technique. In some embodiments, implementing the HBPOC plan may include providing patient care services in accordance with the HBPOC plan, as depicted at block 502. For example, with regard to the HBPOC plan/schedule provided in FIG. 3C, the nurse “Jackie Smith” may visit the patient in the home and administer medications two times per day (e.g., at or around 9 am and 4 pm), the phlebotomist “Mike Green” may visit the patient in their home and take a blood sample once per day (e.g., at or around 10 am), the physical Therapist (PT) “John Lane” may visit the patient in their home and conduct physical therapy on the second and third days (e.g., at or around 2 pm-3 pm).

Although only a few services are described for illustration purposes, it will be appreciated that the HBPOC plan and/or implementation of the plan may include any variety of services provided at any suitable time, duration and frequency. In some embodiments, a care provider may be present at the patient's home at the time of the arrival of the patient at the home and/or may maintain a presence after the patient's arrival. For example, one or more care provider may arrive hours before the patient's arrival to ensure that the home is prepared for home-based post-operative care and may remain in the home until the patient no longer needs constant supervision. In some embodiments, post-operative care may include a care provider being present at the patient's home for an extended period of time (e.g., several hours, half a day, a full, day, multiple days, etc.). For example, one or more care providers may be present for the first twenty-four hours after the patient arrives at their home. In some embodiments, care providers may rotate their coverage in shifts, thereby ensuring that the patient is under constant supervision. In some embodiments, care providers may employ an at-home medical kit that includes medications (e.g., a medication pump/reservoir), devices, and other materials that may be used in treating the patient post-operatively. In some embodiments, a phlebotomist may draw fluids from the patient, such as blood, urine, and other biological samples. In some embodiments, the fluids may be analyzed locally (e.g., at or near the patient's home) and/or sent to a diagnostics laboratory for analysis. In some embodiments, an ultrasound specialist may be deployed to the patient's home to provide ultrasound therapy. Other embodiments may include deploying any suitable care providers to the patient's home to provide post-operative treatment of the patient.

In some embodiments, reminders/prompts may be provided to the care providers to alert them to an upcoming task that needs their attention. For example, server 102 may serve a reminder alert/prompt (e.g., a page) to access device 104d of nurse Jackie Smith at 8:30 am on March 2^{nd} including the message of “Reminder: You need to visit Paul Peterson at 9 am to administer medications and report on his general condition.” In some embodiments, similar reminders may be provided for some or all of the tasks by some or all of the care providers. Such reminders may facilitate coordination of remotely located care providers (e.g., mobile care providers that are generally remote from the hospital and/or the home) to provide services and ensure that the HBPOC plan is implemented as intended.

In some embodiments, a care provider may be able to access a webpage or similar content page to review a patient's care information and/or when they are next required to provide services to the patient. For example, around 7 am on March 2^{nd}, Nurse Jackie Smith may log-in (e.g., via application 110d of her access device 104d) to the “patient care website” served by care coordinator server 102, and request to access the patient's records. In response to the request, server 102 may serve content, such as a webpage similar to that of webpage 300c, including the schedule/log corresponding to the HBPOC plan. Nurse Jackie Smith may, then determine that she needs to visit Paul Peterson at 9 am based on the schedule. In some embodiments, a care provider may be presented with a listing of one or more tasks that require their attention. For example, where the care provider Jackie Smith is responsible for providing services to multiple patients receiving home-based care (e.g., Paul Peterson and John White), Jackie Smith may log-in (e.g., via application 110d of her access device 104d) to the “patient care website” served by care coordinator server 102, and request to access her “To-Do List” including a schedule of services/tasks that she is personally responsible for. In response to the request, server 102 may serve content, such as a webpage including a “Nurse Jackie Smith's To-Do” list listing required visits to Paul Peterson's home at 9 am and 4 pm as well as required visits to John White's home at 11 am and 6 pm. Accordingly, Nurse Jackie Smith may determine that she needs to visit Paul Patient and John White based on accessing her to-do list and, thus, may not need to visit a webpage for each of the patients individually to determine what services she needs to provide.

In some embodiments, the patient may be able to provide an alert to request medical attention. In some embodiments, upon determining that they are in need of care, the patient may submit a request for medical attention, a care provider may be alerted/prompted, and may respond to the request. For example, in response to experiencing a high level of pain, the patient may submit a request for pain medication (e.g., via application 110e of access device 104e), server 102 may process the request, and serve a corresponding alert (e.g., a page) to a nurse currently on-call (e.g., via application 110d of access device 104d). In response to the alert, the nurse, if not already there, may travel to the patient's home to evaluate the patient, administer pain medication, and/or provide medical attention as necessary.

Method 500 may include logging patient information, as depicted at block 504. In some embodiments, logging patient information may include care providers recording information regarding interactions with the patient, including information regarding services provided and/or the status/condition of the patient. For example, upon visiting the patient and administering medications in accordance with a task listed in the post-operative-schedule/log, nurse Jackie Smith may provide a log entry indicative of a time of the visit, the administering of medications and/or the general condition of the patient.

In some embodiments, the medical practitioner may log patient information using care coordination system 100. For example, upon completion of the task of visiting the patient and administering medications around 9 am on March 2^{nd}, nurse Jackie Smith may log-in (e.g., via application 110d of her access device 104d) to the “patient care website” served by care coordinator server 102, and request to access the patient's records. In response to the request, server 102 may serve content, such as a webpage similar to that of webpage 300c, including the schedule/log corresponding to the HBPOC plan. Nurse Jackie Smith may, then (e.g., using access device 104d), enter a log entry note, such as “@9:05 am; Admin. Pain Meds; Patient Comfortable”. In some embodiments, a care provider may have the option to mark a field as “critical” to ensure that a proper level of attention is being paid to the entry. In some embodiments, a note marked as non-critical (e.g., “N”) may be processed in due course. For example, the surgeon may review the note during a daily review of the patient information. In some embodiment, a note marked as critical (e.g., “Y”) may be flagged for expedited processing. For example, upon submission of the note, server 102 may process the note and serve an alert/prompt to the surgeon that he/she needs to review the note immediately. In some embodiments, updated information, including the updated tasks/log notes, may be submitted to server 102 upon selection of the “Submit” button. In some embodiments, the patient's information stored at datastore 112 may be updated to reflect the updated tasks/log note information.

In some embodiments, similar log entries may be submitted by the various care providers. For example, the phlebotomist and the physical therapist (PT) may provide similar log entries including notes describing their tasks, the patient's condition and so forth. In some embodiments, each of the care providers may have their own access device (e.g., a cell phone, PDA, or tablet) such that they may submit log entries from various locations, including the patient's home. In some embodiments, care providers may submit log entries via patient access device 104e, located in the patient's home environment 106.

FIG. 3D depicts an exemplary patient care webpage 300d including log entries in accordance with one or more embodiments of the present technique. In the illustrated embodiment, post-operative schedule/log 308 includes log entries that were entered by Nurse Jackie and Mike Green regarding their visits to the patient on March 2^{nd}. Although the illustrated embodiment includes the notes being written over the tasks (e.g., “@9:05 am; Admin. Pain Meds; Patient Comfortable” being written in place of “Administer Pain Meds; Report Condition”), other embodiments may include various forms of logging information. For example, separate columns may be provided for the tasks and the notes such that both remain visible to facilitate review of the log entries relative to the requested tasks.

Method 500 may include review of patient information, as depicted at block 506. In some embodiments, review of patient information may be conducted by a medical practitioner on a regular basis (e.g., hourly, twice per day, once per day, or the like) to determine whether home-based post-operative care is progressing as planned and/or whether or not changes to the post-operative care need to be made. For example, Dr. Smith, as scheduled (e.g., once per day at or around 6:00 pm), may log-in (e.g., via application 110a of access device 104a) to the “care website” and request to access the patient's record. In response to the request, server 102 may serve content, such as a webpage similar that of webpage 300d of FIG. 3D, the patient's current information including log entries of tasks/notes prior to the time of review. Upon reviewing the patient's information, the surgeon may select (or leave selected) the radio button for “Qualified” to indicate that the patient is still qualified for home-based post-operative care, or the surgeon may select the radio button for “Not Qualified” to indicate that the patient no longer qualifies for home-based post-operative care. The medical practitioner may make modifications to other portions of the patient information. For example, the surgeon may enter additional notes regarding the patient's condition in the “General Notes” of patient information 306.

In some embodiments, a medical practitioner may interact with the patient remotely (e.g., via access devices 104a and 104e). For example, during the review of patient information, the surgeon may interact with the patient orally via a phone and/or interact with the patient visually via a video conference. Such a technique may enable the medical practitioner to gather a great deal of information regarding the patient's condition without having to visit the patient's home or having the patient return to the medical facility.

In some embodiments, the surgeon may provide a log entry indicative of his/her review and evaluation of the post-operative care. For example, the surgeon may enter a log entry note such as “@6:05 pm; Review Patient Info; Remains Qualified for HBPOC”. In some embodiments, updated information, including the information entered as a result of the review, may be submitted to server 102 upon selection of the “Submit” button. In some embodiments, the patient's information stored at datastore 112 may be updated to reflect the surgeons review, including the evaluation that that the patient does or does not qualify for home-based post-operative care and/or the information entered by the surgeon.

Method 500 may include determining whether a patient remains qualified for home-based post-operative care, as depicted at block 508. In some embodiments, determining whether a patient qualifies for home-based post-operative care may be based on the review of the patient information at block 506. For example, server 102 may determine that a patient remains qualified for home-based post-operative care based on the surgeon's selection and submission of “Qualified”. As a further example, server 102 may determine that a patient does not remain qualified for home-based post-operative care based on the surgeon's selection and submission of “Not Qualified”.

In some embodiments, where it is determined that a patient does not remain qualified for home-based post-operative care, method 500 may include proceeding to scheduling on-site post-operative care, as depicted at block 509. In some embodiments, scheduling on-site post-operative care may the same or similar to that described above with regard to block 206. Accordingly, a new post-operative plan for on-site care may be generated and the patient may return to a medical facility for on-site post-operative care.

In some embodiments, where it is determined that a patient does remain qualified for home-based post-operative care, method 500 may include proceeding to determining whether the post-operative requirements have changed, as depicted at block 510. In some embodiments, determining whether the post-operative requirements have changed may be based on whether or not changes have been made to the post-operative requirements by the medical practitioner during the review of patient information at block 506. For example, server 102 may determine that the post-operative requirements have changed where the surgeon has changed the information listed in the post-operative requirements section 306 of the patient care webpage (e.g., added requirements for days four and five of the home-based post-operative care). As a further example, server 102 may determine that the post-operative requirements have not changed where the surgeon has not changed the information listed in the post-operative requirements section 306 of the patient care webpage. In some embodiments, where it is determined that the post-operative requirements have changed, method 500 may include proceeding to updating the home-based post-operative care plan, as depicted at block 512. In some embodiments, updates to the home-based post-operative care plan may be provided in a manner that is the same or similar to the technique described above with regard to block 224.

In some embodiments, where it is determined that the post-operative requirements have not changed and/or the HBPOC plan has been updated accordingly, method 500 may include proceeding to determining whether home-based post-operative care is complete, as depicted at block 514. In some embodiments, determining whether a patient qualifies for home-based post-operative care may be based on the patient care information. For example, server 102 may determine that home-based post-operative care is complete upon reaching the time for the last tasks in post-operative schedule log 308 (e.g., March 5^{th} at 9 am) and/or receiving a log entry indicating completion of the last tasks (e.g., the note “@9:10 am; Patient Comfortable; Clear Patient for Outpatient PT” for the task of “Visit Patient; Clear Patient for Other Services”). Accordingly, the implementation of the HBPOC plan including providing patient care services in accordance with the HBPOC plan, the logging of patient information, the review of patient information and so forth may continue until the HBPOC plan is complete or otherwise terminated.

FIG. 3E depicts an exemplary patient care webpage 300e including a complete listing of logged tasks/notes in accordance with one or more embodiments of the present technique. In the illustrated embodiment, post-operative schedule/log 308 may include log entries provided throughout implementation of the HBPOC plan.

Returning to method 200 of FIG. 2B, in some embodiments, upon determining that home-based post-operative care is complete, method 200 may include proceeding to clearing the patient for other post-operative care services, as depicted at block 230. For example, the patient may be cleared to attend out-patient physical therapy as opposed to being restricted to physical therapy provided at home.

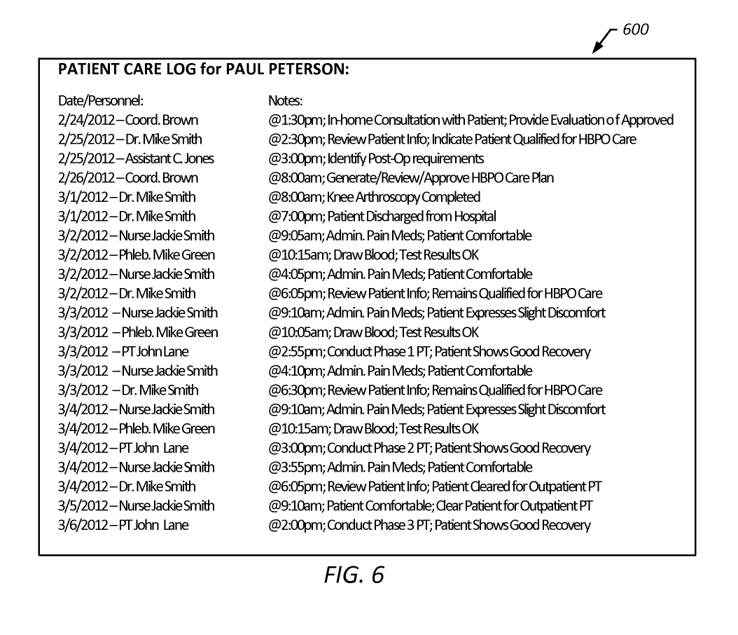

Method 200 may include storing a patient record, as depicted at block 232. In some embodiments, a patient record may be generated based at least in part on pre-operative actions, operative actions, and/or post-operative actions, including those recorded in the schedule/log generated during implementation of the HBPOC plan. FIG. 6 depicts an exemplary patient care log(“patient care record”) 600 in accordance with one or more embodiments of the present technique. Patient care record may include entries that reflect pre-operative actions (e.g., pre-operative evaluation—“Feb. 25, 2012—Dr. Mike Smith @2:30 pm; Review Patient Info; Indicate Patient Qualified for HBPOC”) and post-operative actions, including those recorded in the schedule/log generated during implementation of the HBPOC plan (e.g., post-operative log—“Mar. 5, 2012—Nurse Jackie Smith @9:10 am; Patient Comfortable; Clear Patient for Outpatient PT”). In some embodiments, updated information, including patient care record 600, may be stored at datastore 112. Patient care record 600 may be continually updated as new log information is received. In some embodiments, patient care record 600 may be stored in accordance with medical regulations. For example, patient care record 600 may be stored for at least seven to ten years following the patient's procedure and/or recovery period.

Methods 200, 400 and 500 are an exemplary embodiments of methods employed in accordance with techniques described herein. Methods 200, 400 and 500 may be may be modified to facilitate variations of its implementations and uses. Methods 200, 400 and 500 may be implemented in software, hardware, or a combination thereof. Some or all of methods 200, 400 and 500 may be implemented by module 114 and/or applications 110. The order of methods 200, 400 and 500 may be changed, and various elements may be added, reordered, combined, omitted, modified, etc.

FIG. 7 illustrates an exemplary computer system 1000 in accordance with one or more embodiments of the present technique. In some embodiments, computer system 1000 may include a processor 1002, memory 1004, input/output devices(s) 1006, and network interface 1008.

A processor may include a single processor device and/or a plurality of processor devices (e.g., distributed processors). A processor may be any suitable processor capable of executing/performing instructions. A processor may include a central processing unit (CPU) that carries out program instructions to perform arithmetical, logical, and input/output operations of computer system 1000. A processor may receive instructions and/or data from a memory (e.g., system memory 1004).

Memory 1004 may include a tangible program carrier and/or a non-transitory computer readable storage medium. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. Memory 1004 may include a non-transitory computer readable storage medium having program instructions stored thereon that are executable by a computer processor (e.g., processor 1002) to cause aspects of the subject matter and the functional operations described herein. Memory 1004 may include a single memory device and/or a plurality of memory devices (e.g., distributed memory devices).

I/O devices 1006 may include any device that provides for receiving input (e.g., from a user) and/or providing output (e.g., to a user). I/O devices 1006 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like.

Network interface 1008 may include a network adapter that provides for connection of computer system 1000 to a network. Network interface may 1008 may facilitate data exchange between computer system 1000 and other devices connected to the network. Network interface 1008 may support wired or wireless communication. The network may include an electronic communication network, such as the Internet, a local area network (LAN), a wide area (WAN), a cellular communications network or the like.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may, in some embodiments, be combined in fewer components or distributed in additional components. Similarly, in some embodiments, the functionality of some of the illustrated components may not be provided and/or other additional functionality may be available.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Any headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

The techniques described herein may include or otherwise be used in conjunction with techniques described in U.S. Provisional Patent Application No. 61/452,471 filed on Mar. 14, 2011, entitled “HOME BASED POST-OPERATIVE CARE METHOD AND SYSTEM”, the disclosure of which is hereby incorporated by reference in its entirety.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, any such conflicting text in such incorporated by reference U.S. patents, U.S. patent applications, and other materials is specifically not incorporated by reference in this patent.

What is claimed is:

1. A computer-implemented method for providing home-based post-operative care of a patient following a surgical procedure, the method comprising:
receiving patient information indicative of results of a pre-operative evaluation of whether a patient is qualified for home-based post-operative care;
determining that the patient is qualified for home-based post-operative care based at least in part on the patient information received;
identifying one or more post-operative requirements;
in response to determining that the patient is qualified for home-based post-operative care, generating a home-based post-operative care plan based at least in part on the one or more post-operative requirements;
receiving updated patient information indicative of results of a post-operative evaluation of whether the patient remains qualified for home-based post-operative care, the updated patient information indicative of a result of the surgical procedure;
determining that the patient remains qualified for home-based post-operative care based at least in part on the updated patient information received; and
implementing the home-based post-operative care plan, comprising:
discharging the patient from a medical facility such that the patient may be transported to a home-environment for post-operative care;
coordinating visits of one or more care providers to the home environment;
receiving visit information indicative of interactions of one or more care providers with the patient in the home environment;
logging, with a processor, the visit information; and
providing for display of the visit information for review by a medical practitioner, the visit information for use in evaluating the patient being cared for under the home-based post-operative care plan.

2. The method of claim 1, wherein the pre-operative evaluation comprises a personal visit of the home environment by a medical practitioner.

3. The method of claim 1, wherein receiving patient information indicative of results of a pre-operative evaluation of whether a patient is qualified for home-based post-operative care comprises receiving a user input specifying that the patient is qualified for home-based post-operative care.

4. The method of claim 1, further comprising receiving user input of a schedule of services to be provided by one or more care providers via visits to the home environment, wherein generating a home-based post-operative care plan comprises generating a home-based post-operative plan based on the schedule of services.

5. The method of claim 1, wherein the home-based post-operative care plan specifies a schedule for one or more care providers to visit the home environment.

6. The method of claim 1, wherein the home-based post-operative care plan specifies services to be provided by one or more care providers in the home environment.

7. The method of claim 1, wherein receiving updated patient information indicative of results of a post-operative evaluation of whether the patient remains qualified for home-based post-operative care comprises receiving notes regarding an outcome of the surgical procedure.

8. The method of claim 1, further comprising:
identifying one or more updated post-operative requirements based at least in part on the updated patient information; and
updating the home-based post-operative care plan based at least in part on the one or more updated post-operative requirements identified.

9. The method of claim 1, wherein coordinating visits to the home environment comprises providing, to one or more care providers, one or more alerts indicative of a need for a task to be performed in the home environment in accordance with the home-based post-operative care plan.

10. The method of claim 1, wherein the one or more care providers comprises at least one of a nurse, a physician's assistant, a phlebotomist, a physical therapist, or an ultrasound specialist.

11. The method of claim 1, wherein receiving visit information indicative of interactions of one or more care providers with the patient in the home environment comprises receiving, via a mobile access device of a care provider, a note corresponding to a task performed in the home environment.

12. The method of claim 1, wherein receiving visit information indicative of interactions of one or more care providers with the patient in the home environment comprises receiving, via a mobile access device of a care provider, a note corresponding to a condition of the patient while being cared for in the home environment.

13. The method of claim 1, wherein logging, by a processor, the visit information comprises:
receiving one or more log entries provided by one or more care providers; and
storing, in a patient care record for the patient, information corresponding to the one or more log entries.

14. The method of claim 1, wherein implementing the home-based post-operative care plan comprises conducting an evaluation to determine whether or not the patient remains qualified for home-based post-operative care.

15. The method of claim 1, wherein implementing the home-based post-operative care plan comprises conducting an evaluation of the patient from a location that is remote to the home environment.

16. The method of claim 1, wherein implementing the home-based post-operative care plan comprises providing an oral conference between a medical practitioner and the patient, wherein the patient is located in the home environment and the medical practitioner is located remote from the home environment, such that the medical practitioner can assess a condition of the patient from a remote location.

17. The method of claim 1, wherein implementing the home-based post-operative care plan comprises providing a video conference between a medical practitioner and the patient, wherein the patient is located in the home environment and the medical practitioner is located remote from the home environment, such that the medical practitioner can assess a condition of the patient from a remote location.

18. The method of claim 1, further comprising:
receiving other patient information indicative of results of another pre-operative evaluation of whether another patient is qualified for home-based post-operative care;
determining that the other patient is not qualified for home-based post-operative care based at least in part on the patient information received; and
in response to determining that the other patient is not qualified for home-based post-operative care, scheduling onsite post-operative care for the other patient.

19. A computer-implemented method, comprising:
serving, to a first client device, a content page comprising a data input field for the entry of home-evaluation information;
receiving, from the first client device prior to the patient being provided home-based post-operative care within a home environment, home-evaluation information indicative of results of an on-site evaluation of the home environment, the home-evaluation information having been provided via the data input field;
storing the home-evaluation information; and
in response to receiving a request for patient information, serving, to a second client device, patient information comprising at least a portion of the home-evaluation information, the patient information configured to be displayed to a user for use in evaluating whether the patient qualifies for home-based post-operative care within the home environment.

20. A computer-implemented method, comprising:
serving, to a first client device, a content page comprising a data input field for the entry of visit information indicative of home-based post-operative care services provided by a care provider to a patient;
receiving, from the client device, visit information indicative of home-based post-operative care services provided by the care provider to the patient, the visit information having been provided via the data input field;
storing the visit information; and
in response to receiving a request for patient information, serving, to a second client device, patient information comprising at least a portion of the visit information, the patient information configured to be displayed to a user for use in evaluating post-operative care services provided to the patient.
